(19) United States
(12) Patent Application Publication
(10) Pub. No.: US 2016/0157228 A1
(43) Pub. Date: Jun. 2, 2016

(54) METHOD FOR SIGNALING UE CAPABILITY CHANGE AND APPARATUS THEREFOR

(71) Applicant: LG ELECTRONICS INC., Seoul (KR)

(72) Inventors: Kunil YUM, Seoul (KR); Daesung HWANG, Seoul (KR); Kijun KIM, Seoul (KR); Yunjung YI, Seoul (KR)

(73) Assignee: LG ELECTRONICS INC., Seoul (KR)

(21) Appl. No.: 14/954,719

(22) Filed: Nov. 30, 2015

Related U.S. Application Data
(60) Provisional application No. 62/085,342, filed on Nov. 28, 2014.

(51) Int. Cl. H04W 72/04; H04L 5/00; H04W 76/04

(52) U.S. Cl. CPC H04W 72/0446; H04W 76/046; H04L 5/0007; H04W 88/02

(57) ABSTRACT

A method for notifying of change of capability of a terminal (hereinafter, “terminal capability”) without radio resource control (RRC) connection reconfiguration in a wireless communication system includes: transmitting a second message for notifying that terminal capability is variable to an base station upon reception of a first message for inquiring about terminal capability; transmitting a third message for notifying of terminal capability change to the base station when the terminal capability has changed, wherein the third message triggers transmission of a fourth message for inquiring about the changed terminal capability; receiving the fourth message for inquiring about the terminal capability from the base station; and transmitting a fifth message including information about the changed terminal capability to the base station.

### CROSS-REFERENCE TO RELATED APPLICATION

Pursuant to 35 U.S.C. §119(e), this application claims the benefit of U.S. Provisional Patent Application No. 62/085,342, filed on Nov. 28, 2014, the contents of which are hereby incorporated by reference herein in its entirety.

### BACKGROUND OF THE INVENTION

1. Field of the Invention

The present invention relates to a wireless communication system and, more specifically, to a method for signaling UE capability change and an apparatus therefor.

2. Discussion of the Related Art

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### SUMMARY OF THE INVENTION

Accordingly, the present invention is directed to a method for signaling UE capability change to enable more efficient signaling of UE capability change and UE or eNB operation related thereto.

The technical problems solved by the present invention are not limited to the above technical problems and those skilled in the art may understand other technical problems from the following description.

According to an embodiment of the present invention, there is provided a method for notifying change of capability of a terminal (hereinafter, “terminal capability”) without radio resource control (RRC) connection reconfiguration in a wireless communication system, the method including: transmitting a second message for notifying that terminal capability is variable to a base station upon reception of a first message for inquiring about terminal capability; transmitting a third message for notifying terminal capability change to the base station when the terminal capability has changed, wherein the third message triggers transmission of a fourth message for inquiring about the changed terminal capability; receiving the fourth message for inquiring about the terminal capability from the base station; and transmitting a fifth message including information about the changed terminal capability to the base station.

Alternatively or additionally, the method may further include periodically checking whether the terminal capability has changed.

Alternatively or additionally, the information about the changed terminal capability may include information about the entire capability of the terminal or information about capability changed or added from among information about capability previously notified by the terminal.

Alternatively or additionally, the method may further include transmitting a sixth message for notifying an information set about variable terminal capability to the base station.

Alternatively or additionally, the method may further include reporting, to the base station, feedback information according to the changed terminal capability irrespective of whether the base station has changed setup for the terminal capability, when the terminal capability has changed.

Alternatively or additionally, the information set about the terminal capability may be predetermined according to individual information of the feedback information.

Alternatively or additionally, the setup for the terminal capability may be changed into the predetermined information set about the terminal capability.

According to an embodiment of the present invention, there is provided a terminal configured to notify of change of capability of a terminal (hereinafter, “terminal capability”) without RRC connection reconfiguration in a wireless communication system, the terminal including: a radio frequency (RF) unit; and a processor configured to control the RF unit, wherein the processor is configured to transmit a second message for notifying that terminal capability is variable to a base station upon reception of a first message for inquiring about terminal capability, to transmit a third message for notifying of terminal capability change to the base station when the terminal capability has changed, the third message triggering transmission of a fourth message for inquiring about the changed terminal capability; to receive the fourth message for inquiring about the terminal capability from the base station and to transmit a fifth message including information about the changed terminal capability to the base station.

Alternatively or additionally, the processor may be configured to periodically check whether the terminal capability has changed.

Alternatively or additionally, the information about the changed terminal capability may include information about the entire capability of the terminal or information about capability changed or added from among information about capability previously notified by the terminal.

Alternatively or additionally, the processor may be configured to transmit a sixth message for notifying an information set about variable terminal capability to the base station.

Alternatively or additionally, the processor may be configured to report, to the base station, feedback information according to the changed terminal capability irrespective of whether the base station has changed setup for the terminal capability, when the terminal capability has changed.

Alternatively or additionally, the information set about the terminal capability may be predetermined according to individual information of the feedback information.

Alternatively or additionally, the setup for the terminal capability may be changed to the predetermined information set about the terminal capability.

The aforementioned technical solutions are merely parts of embodiments of the present invention and various embodiments in which the technical features of the present invention are reflected can be derived and understood by a person skilled in the art on the basis of the following detailed description of the present invention.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A and 1B illustrate an exemplary radio frame structure used in a wireless communication system;

FIG. 2 illustrates an exemplary downlink/uplink (DL/UL) slot structure in a wireless communication system;

FIG. 3 illustrates an exemplary downlink (DL) subframe structure used in a 3GPP LTE/LTE-A system;

FIG. 4 illustrates an exemplary uplink (UL) subframe structure used in a 3GPP LTE/LTE-A system;

FIG. 5 illustrates radio link failure;

FIG. 6 illustrates a successful connection re-establishment procedure;

FIG. 7 illustrates connection reestablishment failure;

FIG. 8 illustrates a radio resource control (RRC) connection reconfiguration procedure;

FIG. 9 illustrates UE capability inquiry and UE capability report procedures in an RRC connection configuration procedure;

FIG. 10 illustrates a procedure of signaling UE capability change according to an embodiment of the present invention;

FIG. 11 illustrates a procedure of signaling UE capability change according to an embodiment of the present invention;

FIG. 12 illustrates an example in which UE capability is variable;

FIG. 13 illustrates a procedure of signaling UE capability change according to an embodiment of the present invention;

FIG. 14 illustrates a procedure of signaling UE capability change according to an embodiment of the present invention; and

FIG. 15 is a block diagram of an apparatus for implementing embodiments of the present invention.

### DETAILED DESCRIPTION OF THE INVENTION

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

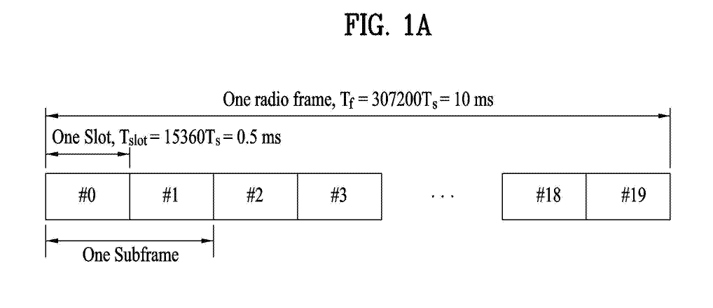

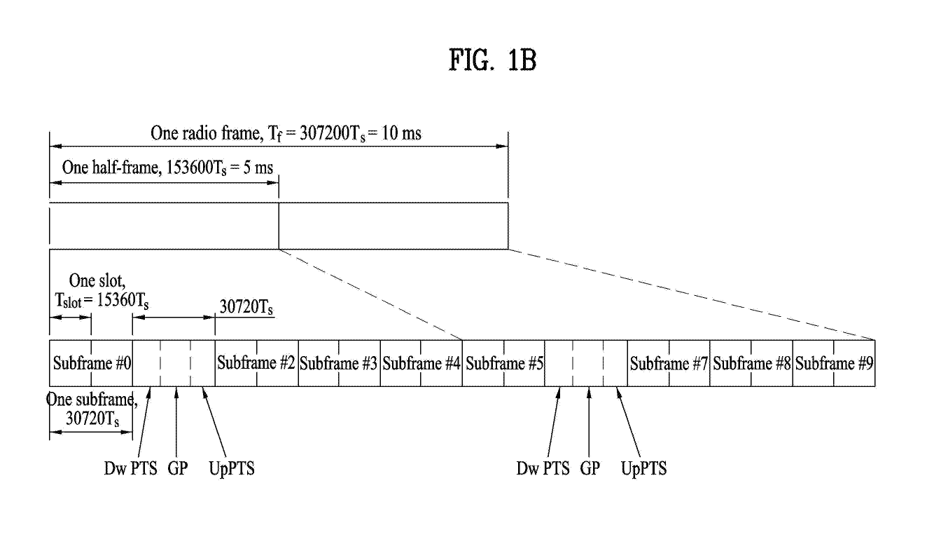

FIGS. 1A and 1B illustrate an exemplary radio frame structure used in a wireless communication system. FIG. 1A illustrates a frame structure for frequency division duplex (FDD) used in 3GPP LTE/LTE-A and FIG. 1B illustrates a frame structure for time division duplex (TDD) used in 3GPP LTE/LTE-A.

Referring to FIG. 1A, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| DL-UL | to-Uplink | | | | | | | | | | |
| con- | Switch-point | Subframe number | | | | | | | | | |
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal cyclic | Extended | | Normal | Extended |
| subframe | | prefix in | cyclic prefix | | cyclic prefix | cyclic prefix |
| configuration | DwPTS | uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

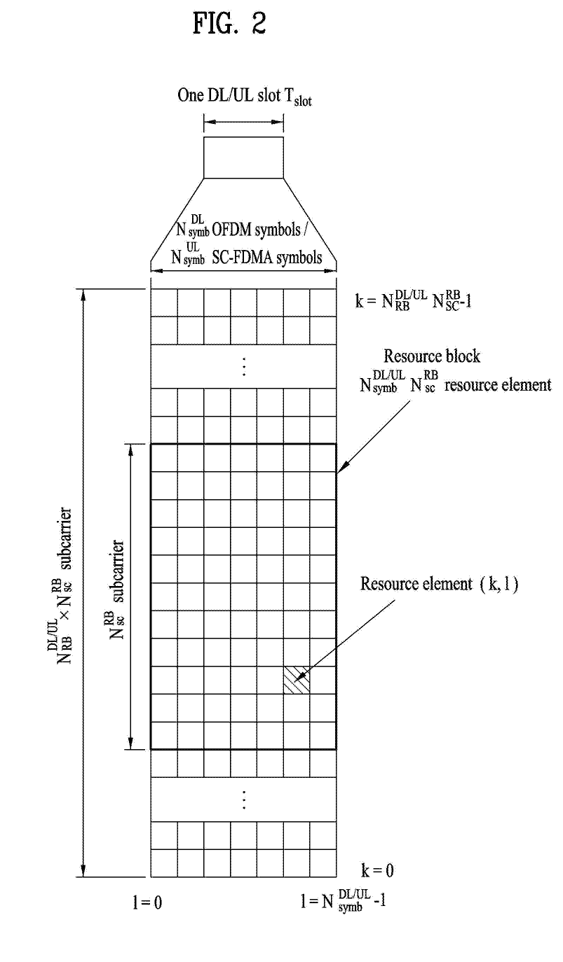

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

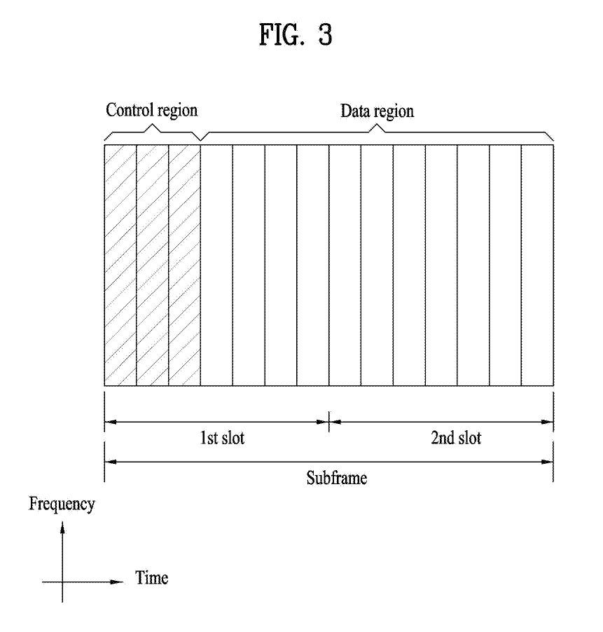

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| | | | Number of |
|---|---|---|---|
| Search Space | | | PDCCH |
| | Aggregation | Size [in | candidates |
| Type | Level L | CCEs] | M^{(L)} |
| UE- | 1 | 6 | 6 |
| specific | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

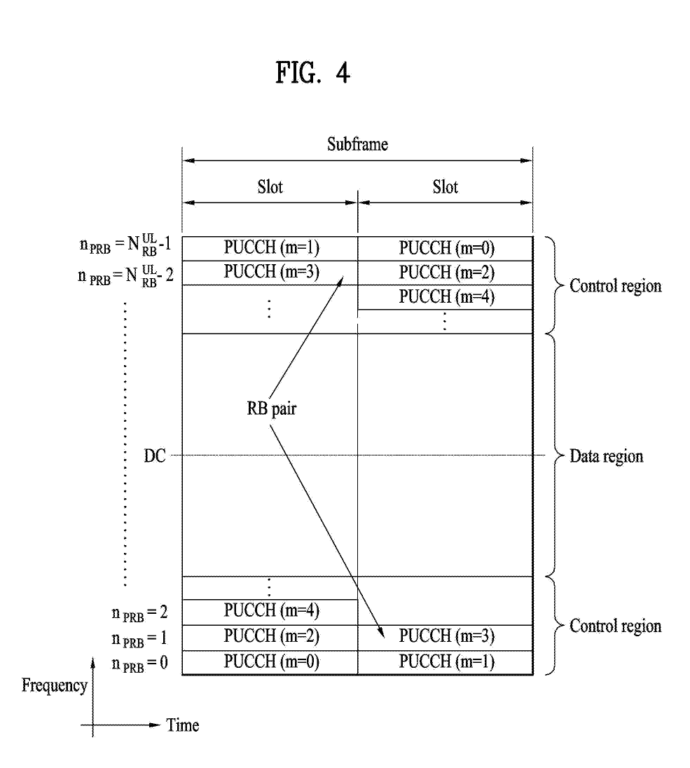

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 4 shows the mapping relationship between PUCCH formats and UCI in LTE/LTE-A.

TABLE 4

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One codeword |
| | | | SR + ACK/NACK | |
| 1b | QPSK | 2 | ACK/NACK or | Two codeword |
| | | | SR + ACK/NACK | |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK | |
| | | | or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

A UE consistently performs measurement in order to maintain quality of a radio link with a serving cell providing services thereto. The UE checks whether communication is not available due to deterioration of quality of the radio link with the serving cell. When the UE concludes that the current quality of the radio link with the serving cell is so low that communication is unavailable, the UE determines radio link failure. In the case of radio link failure, the UE abandons communication with the current serving cell, selects a new cell through a cell selection (or cell re-selection) procedure and attempts RRC connection re-establishment for the new cell.

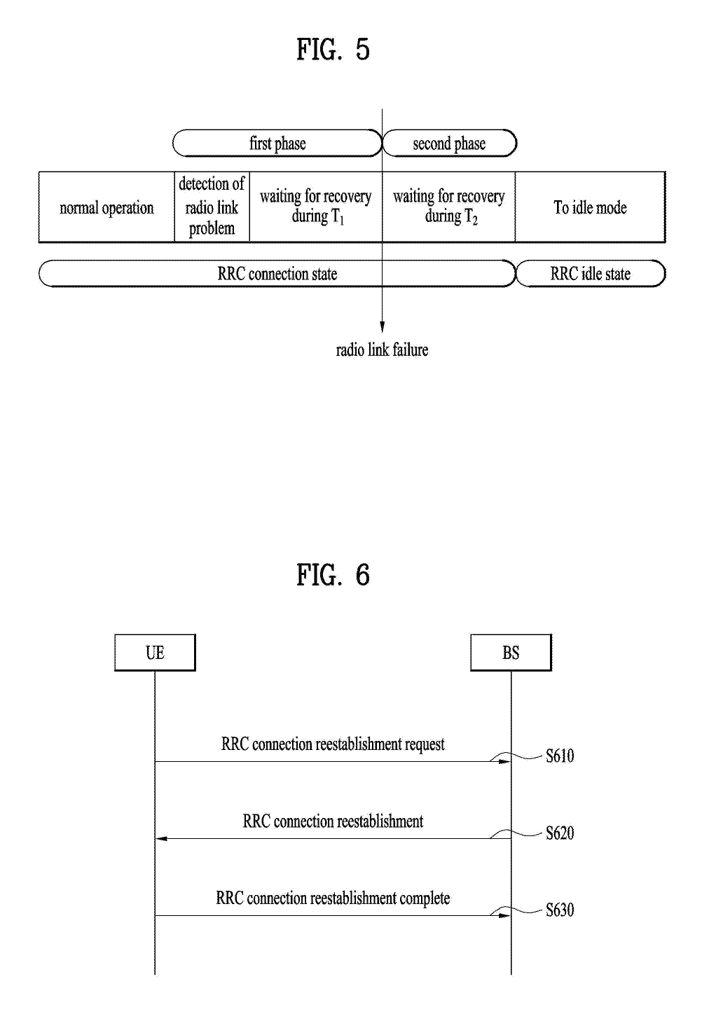

FIG. 5 illustrates radio link failure. Operation related to radio link failure can be described in two phases.

During the first phase, the UE performs normal operation and checks whether the current communication link has trouble. If a problem is detected from the current communication link, the UE announces a radio link problem and waits for radio link recovery for a first waiting time T1. When the radio link is recovered within the first waiting time T1, the UE resumes normal operation. When the radio link is not recovered after expiration of the first waiting time T1, the UE announces radio link failure and enters the second phase.

During the second phase, the UE waits for recovery of the radio link for a second waiting time T2. When the radio link is not recovered after expiration of the second waiting time T2, the UE enters an RRC idle state. Otherwise, the UE may perform an RRC re-establishment procedure.

The RRC re-establishment procedure is a procedure for re-setting RRC connection in the RRC_CONNECTED state. Since the UE remains in the RRC_CONNECTED state, that is, the UE does not enter the RRC_IDLE state, the UE does not initialize all radio configurations thereof (e.g., a radio bearer configuration). Instead, the UE temporarily suspends use of all radio bearers except SRB when starting an RRC connection reconfiguration procedure. If RRC connection reconfiguration has been successfully performed, the UE resumes use of the temporarily suspended radio bearers.

FIG. 6 is a flowchart illustrating a successful connection re-establishment procedure. The UE selects a cell by performing cell selection. The UE receives system information in order to receive basic parameters for cell access in the selected cell. Then, the UE sends an RRC connection re-establishment request message to a BS (S610).

When the selected cell is a cell having the context of the UE, that is, a prepared cell, the BS accepts the RRC connection re-establishment request of the UE and sends an RRC connection re-establishment message to the UE (S620). The UE sends an RRC connection re-establishment completion message to the BS, thereby accomplishing successful RRC connection re-establishment (S630).

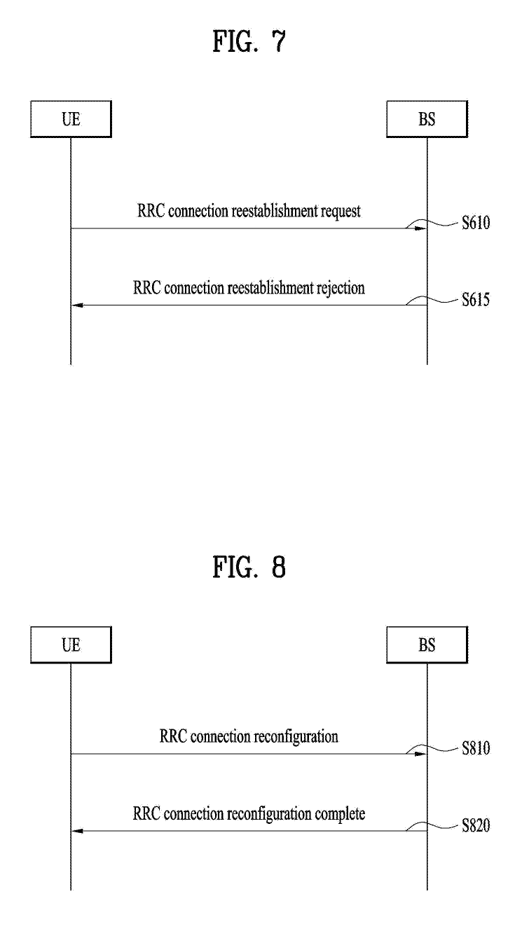

FIG. 7 is a flowchart illustrating connection re-establishment failure. The UE sends an RRC connection re-establishment request message to the BS (S610). If the selected cell is not a prepared cell, the BS sends an RRC connection re-establishment rejection message to the UE as a response to the RRC connection re-establishment request (S615).

FIG. 8 is a flowchart illustrating an RRC connection reconfiguration procedure. RRC connection reconfiguration is used to modify RRC connection. Specifically, RRC connection reconfiguration is used for RB establishment/modification/release, handover, and measurement setup/modification/release.

The BS sends an RRC connection reconfiguration message for modifying RRC connection to the UE (S810). The UE sends an RRC connection reconfiguration completion message used to check successful completion of RRC connection reconfiguration to the corresponding network (S820).

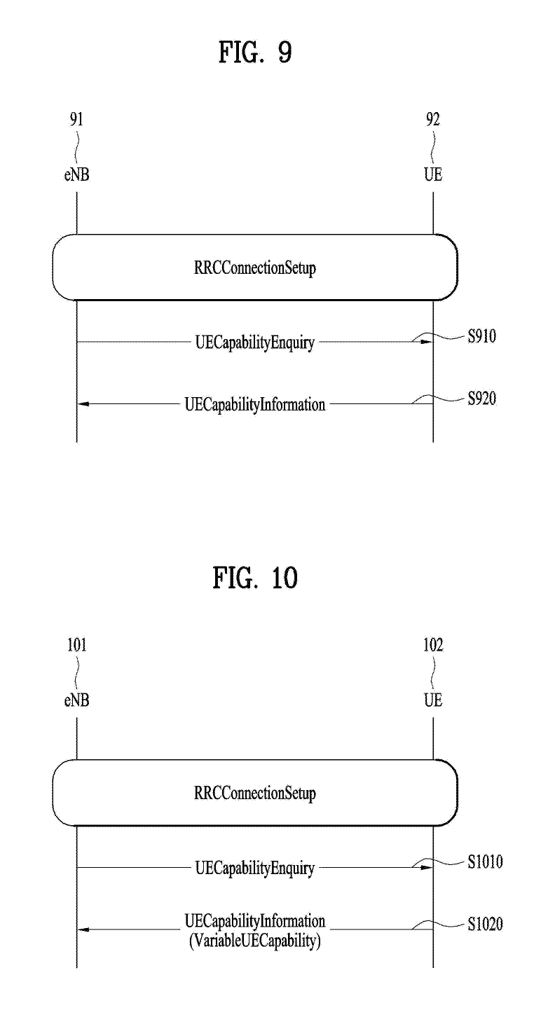

Typical content of UE capability, used in the current LTE system, includes UE category, frequency band, general radio resource information, general MIMO parameters, duplex mode and the like. In the LTE system, UE capability is signaled to the BS in order to appropriately support the UE. UE capability is signaled to the BS through RRC signaling when the UE is attached to the BS, as shown in FIG. 9.

During RRC connection setup, the BS may inquire UE capability of the UE (S910). The UE may report UE capability thereof to the BS as a response to the inquiry (S920).

However, the BS receives the first UE capability report and then frequently uses UE capability stored in the network rather than receiving UE capability from the UE. Even when the UE hands over to another BS, the other BS receives UE capability handed over from the previous BS instead of receiving UE capability from the UE. This is based on the assumption that UE capability is hardware characteristics and thus never changes with time. Accordingly, UE capability hardly changes once the UE is attached to the BS.

As UEs become more compact, schemes for configuring part of components of UEs as external components are considered. For example, hardware capability of a UE can be changed in such a manner that an antenna is attached to/detached from the UE. Accordingly, it is possible to consider a possibility that UE capability can vary according to time, place or a network to which the UE is linked, differently from conventional UE assumption. As examples, the following situations are considered.
UE capability increase/decrease due to use of a peripheral device

A. Additional antenna

B. Additional module (RF, memory or the like)

C. Additional power (i.e., available transmission power increase)

D. Docking station including an additional module
UE capability decrease due to a problem generated in the UE

A. Overheating problem

B. Component damage

C. Temporary low capability operation to conserve power

UE capability change through conventional RRC connection reconfiguration requires a long time. In the case of a UE having considerable UE capability change, UE capability may be remarkably deteriorated. Accordingly, the UE needs to signal UE capability change to the BS without RRC connection reconfiguration.

The UE can notify the BS of the fact that UE capability thereof is variable during RRC connection setup. FIG. 10 illustrates a procedure through which the UE notifies the BS of the fact that UE capability is variable.

Referring to FIG. 10, when the BS inquires UE capability of the UE (S1010), the UE can notify the BS that UE capability thereof is variable through VariableUECapability filed in a UECapabilityInformation message (S1020). In this case, the BS can operate on the assumption that UE capability of the UE is variable with time. Alternatively, the BS may operate without reception of the VariableUECapability field on the assumption that UE capabilities of all UEs are variable with time. Particularly, the BS can assume that even information in the UE category, for example, a peak data rate of the UE, is variable. This may mean that the peak data rate that the UE can support is variable according to UE capability. For example, a maximum data rate that the UE can support is variable as the number of layers supported by the UE changes or carrier aggregation (CA) capability varies.

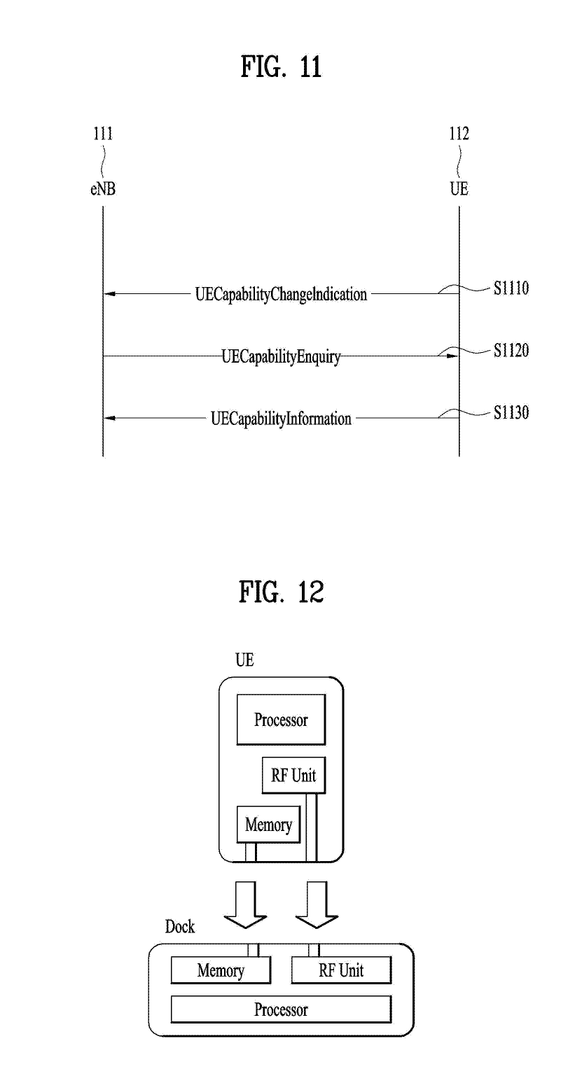

FIG. 11 illustrates a procedure through which the UE notifies the BS of UE capability change when UE capability has changed.

When UE capability has changed, the UE may send a UECapabilityChangeIndication message to the BS (S1110). Transmission of the UECapabilityChangeIndication message can trigger transmission of a UECapabilityEnquiry message. That is, upon reception of the UECapabilityChangeIndication message, the BS can send the UECapabilityEnquiry message to the UE (S1120). Then, the UE can report UE capability thereof as in initial attachment to the BS by sending a UECapabilityInformation message to the BS (S1130).

Alternatively, the UE may previously notify the BS of a set of variable information from among the UE capability. For example, a docking state can hold the UE and share specific capability with the UE held thereby. Simultaneously, the UE can have capability of using part of resources of the docking station by being held by the docking station

FIG. 12 illustrates a situation in which the docking station and the UE can share resources thereof through interfaces thereof. In this case, the UE can previously notify the BS a set of variable information from among the UE capability. Here, it is possible to update only necessary information instead of updating all information through the UECapabilityEnquiry message and UECapabilityInformation message.

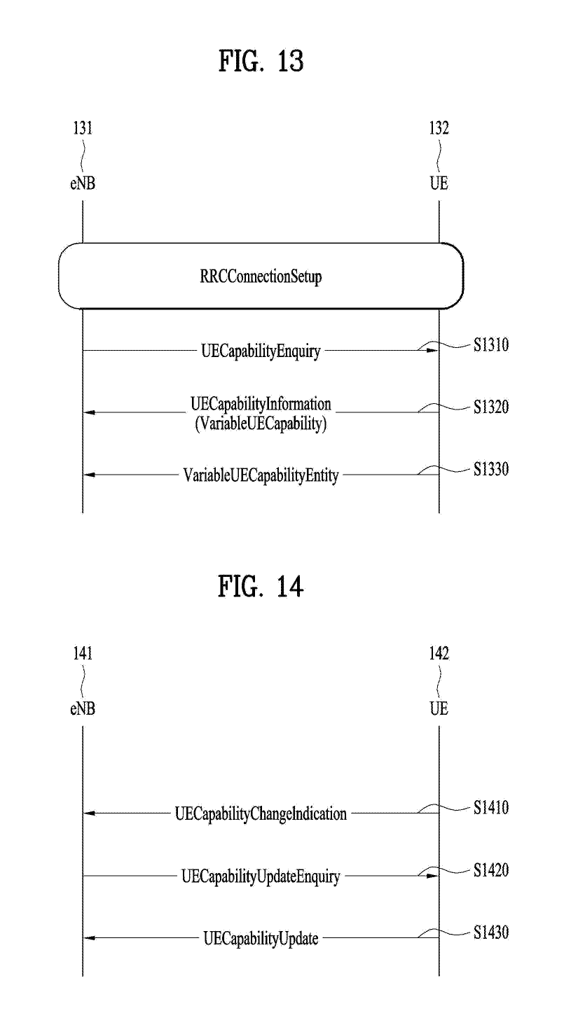

FIG. 13 illustrates a procedure in which the UE previously notifies the BS of a set of variable information from among UE capability.

The BS may send a UECapabilityEnquiry message to the UE (S1310). Then, the UE may notify the BS that UE capability is variable by sending a UECapabilityInformation message including a VariableUECapability field (S1320). Subsequently, the UE may send a VariableUECapabilityEntity message including a set of variable information from among the UE capability to the BS (S1330).

For example, the VariableUECapabilityEntity message can include the following information.

| | |
|---|---|
| UE-EUTRA-Capability ::= | SEQUENCE { |
| ue-Category | INTEGER (1..5), |
| phyLayerParameters | PhyLayerParameters, |
| rf-Parameters | RF-Parameters, |
| } | |
| PhyLayerParameters ::= | SEQUENCE { |

| | |
|---|---|
| ue-TxAntennaSelectionSupported | BOOLEAN, |
| } | |

| | |
|---|---|
| RF-Parameters-v1020 ::= | SEQUENCE { |

| | |
|---|---|
| supportedBandCombination-r10 | SupportedBandCombination-r10 |
| } | |

SupportedBandCombination-r10 ::= SEQUENCE (SIZE (1..maxBandComb-r10)) OF
BandCombinationParameters-r10
BandCombinationParameters-r10 ::= SEQUENCE (SIZE (1..maxSimultaneousBands-r10))
OF BandParameters-r10
BandParameters-r10 ::= SEQUENCE {

| | | |
|---|---|---|
| bandEUTRA-r10 | FreqBandIndicator, | |
| bandParametersUL-r10 | BandParametersUL-r10 | OPTIONAL, |
| bandParametersDL-r10 | BandParametersDL-r10 | OPTIONAL |
| } | | |

BandParametersUL-r10 ::= SEQUENCE (SIZE (1..maxBandwidthClass-r10)) OF CA-
MIMO-ParametersUL-r10
CA-MIMO-ParametersUL-r10 ::= SEQUENCE {

| | |
|---|---|
| ca-BandwidthClassUL-r10 | CA-BandwidthClass-r10, |
| supportedMIMO-CapabilityUL-r10 | MIMO-CapabilityUL-r10 |
| OPTIONAL | |
| } | |

BandParametersDL-r10 ::= SEQUENCE (SIZE (1..maxBandwidthClass-r10)) OF CA-
MIMO-ParametersDL-r10
CA-MIMO-ParametersDL-r10 ::= SEQUENCE {

| | |
|---|---|
| ca-BandwidthClassDL-r10 | CA-BandwidthClass-r10, |
| supportedMIMO-CapabilityDL-r10 | MIMO-CapabilityDL-r10 |
| OPTIONAL | |
| } | |

CA-BandwidthClass-r10 ::= ENUMERATED {a, b, c, d, e, f, ...}
MIMO-CapabilityDL-r10 ::= ENUMERATED {twoLayers, fourLayers, eightLayers}
MIMO-CapabilityUL-r10 ::= ENUMERATED {twoLayers, fourLayers}

Upon reception of the VariableUECapacityEntity message, the BS can recognize that only the information set from among the UE capability can be updated.

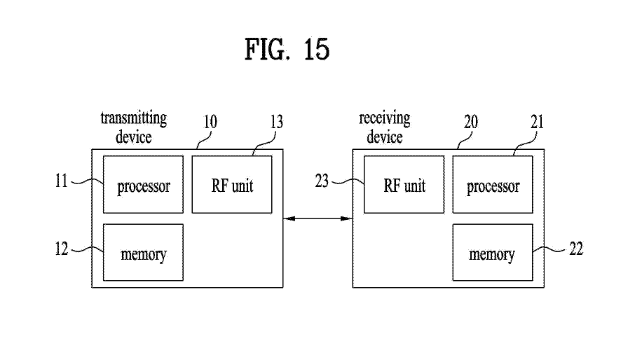

FIG. 14 illustrates a procedure for updating only specific UE capability according to an embodiment of the present invention. When UE capability has changed, the UE may send a UECapabilityChangeIndication message to the BS (S1410). Upon reception of the UECapabilityChangeIndication message, the BS may trigger update of UE capability information by sending a UECapabilityUpdateEnquiry message to the UE (S1420). Upon reception of the UECapabilityUpdateEnquiry message, the UE may update a subset of the variable information set from among the UE capability previously signaled to the BS through the aforementioned VariableUECapabilityEntity message by sending a UECapabilityUpdate message to the BS (S1430). Here, the UECapabilityUpdate message includes the information set or part thereof included in the VariableUECapabilityEntity message. Exemplary information that can be included in the UECapabilityUpdate message is described in the following.

| | |
|---|---|
| UE-EUTRA-Capability ::= | SEQUENCE { |
| ue-Category | INTEGER (1..5), |
| rf-Parameters | RF-Parameters, |
| } | |
| RF-Parameters-v1020 ::= | SEQUENCE { |

| | |
|---|---|
| supportedBandCombination-r10 | SupportedBandCombination-r10 |
| } | |

SupportedBandCombination-r10 ::= SEQUENCE (SIZE (1..maxBandComb-r10)) OF
BandCombinationParameters-r10
BandCombinationParameters-r10 ::= SEQUENCE (SIZE (1..maxSimultaneousBands-r10))
OF BandParameters-r10
BandParameters-r10 ::= SEQUENCE {

| | | |
|---|---|---|
| bandParametersDL-r10 | BandParametersDL-r10 | OPTIONAL |
| } | | |

BandParametersDL-r10 ::= SEQUENCE (SIZE (1..maxBandwidthClass-r10)) OF CA-
MIMO-ParametersDL-r10
CA-MIMO-ParametersDL-r10 ::= SEQUENCE {

| | |
|---|---|
| ca-BandwidthClassDL-r10 | CA-BandwidthClass-r10, |

}
CA-BandwidthClass-r10 ::= ENUMERATED {a, b, c, d, e, f, ...}

Alternatively, the UE may previously report, to the BS, a plurality of categories and UE capability sets supported in the categories and notify the BS of a category supported according to situation or triggering of conditions in which each category is supported.

For example, the UE can report, to the BS, two sets of category and capability as follows.
Set 1: UE category 6+CA 2 CC
Set 2: UE category 10

In addition, the UE can signal which set is used through RRC or MAC signaling.

Alternatively, it is possible to enable one of the two sets to be selected according to specific conditions. That is, the UE category changes according to UE state, and thus the BS can differently apply UE category and capability set according to a signal fed back to the BS. For example,
Set 1: UE category 6+CA 2 CC (default)
Set 2: UE category 10 (when RI feedback from the UE exceeds a maximum rank number of the UE)

In the above case, the BS operates in UE category 6+CA 2 CC state as a default state and can use UE category 10 when the UE feeds back an RI exceeding a maximum rank number of the UE to the BS.

When UE capability has changed, UE operation during a transition time for which the BS changes setting needs to be defined. For example, a soft buffer size of the UE can flexibly increase. In this case, the UE can define an operation of storing received information on the basis of the previous soft buffer size for a predefined transition time as a default operation. Here, the soft buffer size can be extended for the last HARQ process of the last CC.

Conversely, the soft buffer size of the UE can flexibly decrease. In this case, the UE can store received information on the basis of the previous soft buffer size for the predefined transition time. The corresponding buffer unit may not be used for the last HARQ process of the last CC and the following processes according to a size change degree. In this case, the UE is not obligated to receive a signal even when the UE can receive the signal.

In addition, the number of RFs of the UE may flexibly increase. In this case, the UE can maintain the current numbers of ranks/codewords until the next RI feedback. Then, the UE performs RI feedback measured thereby as usual. In this case, the UE may not reflect increased RF capability thereof for the predefined transition time.

If the UE reflects increased UE capability thereof, the BS may receive an RI higher than UE capability known to the BS. That is, the UE can perform operation such as channel measurement according to changed capability thereof irrespective of setting or update of UE capability information in the BS. In this case, the BS can check validity of corresponding RI feedback through an aperiodic CSI request or the like. If the BS has received information about variable UE capability, an RI higher than an RI permitted by UE capability known to the BS has been transmitted, and the corresponding RI feedback is valid, the BS can predict variation of the corresponding UE capability and perform setting according to the changed UE capability even if the BS has not received a UECapabilityChangeIndication message. In this case, UE capability information sets with respect to transmittable RIs can be defined, and a UE capability information set according to a transmitted valid RI can be used. Other UE capability information sets may be defined according to valid feedback information other than the RI, and a UE capability information set according to corresponding feedback information may be used.

FIG. 15 is a block diagram of a transmitting device 10 and a receiving device 20 configured to implement exemplary embodiments of the present invention. Referring to FIG. 15, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

In embodiments of the present invention, a UE serves as the transmission device 10 on uplink and as the receiving device 20 on downlink. In embodiments of the present invention, an eNB serves as the receiving device 20 on uplink and as the transmission device 10 on downlink.

The transmitting device and/or the receiving device may be configured as a combination of one or more embodiments of the present invention.

The embodiments of the present application has been illustrated based on a wireless communication system, specifically 3GPP LTE (-A), however, the embodiments of the present application can be applied to any wireless communication system in which interferences exist.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for notifying of change of capability of a terminal (hereinafter, “terminal capability”) without radio resource control (RRC) connection reconfiguration in a wireless communication system, comprising:
transmitting a second message for notifying that terminal capability is variable to a base station upon reception of a first message for inquiring about terminal capability;
transmitting a third message for notifying of terminal capability change to the base station when the terminal capability has changed, wherein the third message triggers transmission of a fourth message for inquiring about the changed terminal capability;
receiving the fourth message for inquiring about the terminal capability from the base station; and
transmitting a fifth message including information about the changed terminal capability to the base station.

2. The method according to claim 1, further comprising periodically checking whether the terminal capability has changed.

3. The method according to claim 1, wherein the information about the changed terminal capability includes information about the entire capability of the terminal or information about capability changed or added from among information about capability previously notified by the terminal.

4. The method according to claim 1, further comprising transmitting a sixth message for notifying an information set about variable terminal capability to the base station.

5. The method according to claim 1, further comprising reporting, to the base station, feedback information according to the changed terminal capability irrespective of whether the base station has changed setup for the terminal capability, when the terminal capability has changed.

6. The method according to claim 5, wherein the information set about the terminal capability is predetermined according to individual information of the feedback information.

7. The method according to claim 6, wherein the setup for the terminal capability is changed into the predetermined information set about the terminal capability.

8. A terminal configured to notify of change of capability of a terminal (hereinafter, “terminal capability”) without radio resource control (RRC) connection reconfiguration in a wireless communication system, the terminal comprising:
a radio frequency (RF) unit; and
a processor configured to control the RF unit,
wherein the processor is configured to transmit a second message for notifying that terminal capability is variable to a base station upon reception of a first message for inquiring about terminal capability, to transmit a third message for notifying of terminal capability change to the base station when the terminal capability has changed, the third message triggering transmission of a fourth message for inquiring about the changed terminal capability; to receive the fourth message for inquiring about the terminal capability from the base station and to transmit a fifth message including information about the changed terminal capability to the base station.

9. The terminal according to claim 8, wherein the processor is configured to periodically check whether the terminal capability has changed.

10. The terminal according to claim 8, wherein the information about the changed terminal capability includes information about the entire capability of the terminal or information about capability changed or added from among information about capability previously notified by the terminal.

11. The terminal according to claim 8, wherein the processor is configured to transmit a sixth message for notifying an information set about variable terminal capability to the base station.

12. The terminal according to claim 8, wherein the processor is configured to report, to the base station, feedback information according to the changed terminal capability irrespective of whether the base station has changed setup for the terminal capability, when the terminal capability has changed.

13. The terminal according to claim 12, wherein the information set about the terminal capability is predetermined according to individual information of the feedback information.

14. The terminal according to claim 13, wherein the setup for the terminal capability is changed to the predetermined information set about the terminal capability.
